(19) United States
(12) Patent Application Publication
(10) Pub. No.: US 2026/0296809 A1
(43) Pub. Date: Oct. 1, 2026

(54) DEVICE AND METHOD FOR DE-STACKING STACKED ARTICLES

(71) Applicant: SOCIÉTÉ DES PRODUITS NESTLÉ S.A., Vevey (CH)

(72) Inventors: René DELLSPERGER, Steffisburg (CH); Lorenz BÜHLER, Münsingen (CH); Markus BÜRGI, Lyss (CH)

(21) Appl. No.: 19/118,888

(22) PCT Filed: Aug. 21, 2023
(86) PCT No.: PCT/EP2023/072928

§ 371 Date: Mar. 16, 2026

(30) Foreign Application Priority Data
Oct. 7, 2022 (EP) 22200362.6

(51) Int. Cl. B65G 59/10

(52) U.S. Cl. CPC B65G 59/10

(57) ABSTRACT

A device for de-stacking a stack (1) of articles, in particular of cup-like capsules (1.1-1.n), in particular with a peripheral edge, comprises separating elements (2.1, 2.7) for engaging between adjacent articles (1.1, 1.2) of the stack (1) of articles. A plurality of these separating elements (2.1-2.12) are arranged in engagement in the stack (1) all around the stack (1), and the separating elements (2.1-2.12) of the plurality are mounted to be radially movable. The separating elements (2.1-2.12) of the plurality are each mounted resiliently (3.1-3.12), and the device comprises a mechanism (5, 11.1, 11.2) for moving the separating elements (2.1-2.12) of the plurality outwards, into a position of non-engagement in the stack (1). The device permits the automatic de-stacking of stacked articles which are fragile yet at the same time fit firmly into one another and have irregularities in terms of their orientation within the stack.

### TECHNICAL FIELD

The invention relates to a device and a method for de-stacking a stack of articles, in particular cup-like capsules, in particular with a peripheral edge, wherein separating elements are provided for engaging between adjacent articles of the stack of articles. A plurality of these separating elements are arranged around the stack and mounted for radial movement.

### PRIOR ART

Such de-stacking is particularly necessary in manufacturing and processing processes, e.g., when articles of a certain type are stored in stacks or temporarily stored, but processing steps are to be carried out in which these articles must be present individually. This can, for example, be the automatic filling of cup-like capsules, which are initially stacked after their production. In a production line, it is necessary that the de-stacking take place as reliably as possible, quickly, cost-effectively, and with low maintenance. This in turn requires solutions that do not require complicated control mechanisms or sensors.

There are already methods and devices for de-stacking stacked articles. European patent application EP 2 799 350 A1 (ES Plastic GmbH), for example, discloses a device for unstacking trays stacked one inside the other, which are equipped with an, in particular, peripheral edge, with at least one shaft for receiving a stack of trays with a lower, movable separating blade which is arranged to be movable between a closed position in which it closes the shaft on the removal side and an open position in which the lower tray to be removed is released, and vice versa. In addition, the invention includes movable cutting blades that can enter the gaps between the trays and thus hold the stack in the shaft during the separation process, but release the bottom tray.

In addition, the device comprises a driven, movable suction device with at least one suction element for contact with the tray to be removed. This allows a tray to be fixed to the suction device.

A disadvantage of this device becomes apparent when a stack of articles is to be de-stacked in which there are irregular gap sizes between the individual articles of the stack around the periphery of the stack, e.g., due to articles in the stack that are positioned at an angle with respect to the stack axis. In this case, there is a risk that the cutting blades will encounter a gap between the articles that is not large enough for the respective cutting blade to enter. It can then happen that a cutting blade, regardless of a gap size that is too small, takes up its final position facing the stack and thus damages the articles in the stack, e.g., crushes them. Alternatively, the cutting blade could be damaged, or the stack not be de-stacked effectively.

CN 111874643 A (Zhejiang Wie Chi Light Ind Machinery Co Ltd) discloses a de-stacking device for stacked, bowl-shaped cans. This includes curved blades that can penetrate into a gap between the bottom can and the one next to it. To separate the cans, smaller cutting blades, which are integrated into the curved blades, move downwards and push the bottom can away from the stack. The remaining stack is held by the curved blades.

Here, too, the de-stacking process of the stacked cans only works if the gaps between the cans allow the curved blades to engage in the stack.

CN 207 12 12 10 U (Shanghai Maike Machinery Co Ltd) discloses an automatic cup-feeding device for individually removing stacked paper cups. This comprises a guide for storing and holding the stack of cups, wherein the guide includes a cup feed hole through which the cups to be removed pass during removal. It further comprises a plurality of flexible tabs that extend into the cup feed hole. These tabs can deform so that a cup falls through the cup feed hole, but, in their relaxed form, they prevent the stacked cups from falling through. A cup holder under the cup feed hole can use negative pressure to hold a cup in place and pull it away from the stack. During this process, the tabs on the cup feed hole deform enough to allow that cup to pass through, but return to their relaxed shape quickly enough to stop the rest of the stack.

The disadvantage of this device is that the flexible tabs have to deform enough to allow a cup to pass through during removal, but at the same time their spring force is intended to prevent the rest of the stack from passing through. If the cup to be removed is wedged so tightly with the cup next to it that a greater force than the spring force of the tabs is required to separate them, then the device cannot effectively separate these cups from each other.

### PRESENTATION OF THE INVENTION

The object of the invention is to provide a device and a method belonging to the technical field mentioned at the outset, which allow effective de-stacking of stacked articles, in particular cup-like capsules, even when the articles are inclined relative to the stack axis, without the articles being damaged, wherein the device is of simple and cost-effective construction.

The achievement of the object is defined by the features of claims 1 and 12. In the device according to the invention, the separating elements of the plurality are each mounted resiliently, and the device comprises a mechanism for moving the separating elements outwards into a position of non-engagement in the stack.

A stack refers to a set of similar articles that are arranged along a stack axis in such a way that they touch one another, in particular when inserted into one another. This means that no article in the stack can be moved individually along the stack axis without moving other stack articles, unless it is an end article of the stack that can be moved away from the stack along the stack axis. De-stacking refers here to the removal of a stack article from the stack.

The articles can, for example, be open capsules, the cup-like bodies of which have been inserted into one another. The method is particularly suitable for de-stacking cup-like capsules made of a fiber material, which can be easily stacked, but can be easily damaged during de-stacking due to their fragility.

If the article has a peripheral edge, this is a flat, protruding bulge on the article that, of all regions of the article, is furthest from the stack axis.

The separating elements are components that have a suitable shape for engaging in a gap between two articles in the stack of articles to be de-stacked. In the engagement region, their extent in the direction of the stack axis is selected so that it is smaller than the gap size between the articles in the stack, as long as these articles are not inclined with respect to the stack axis. Gap size refers here to the smallest extent of the space in the direction of the stack axis into which the separating elements must enter in order to engage between two articles in the stack.

Engagement is to be understood here to mean that at least a part of the corresponding separating element is located between parts of two adjacent articles of the stack with respect to the stack axis, i.e., a part of the separating element is closer to the stack axis than the article parts above and below the separating element that are furthest away from the stack axis, and the stack cannot be moved freely in any direction along the stack axis without these article parts touching the separating element.

A plurality of separating elements means the totality of a number of more than one separating element, i.e., at least two separating elements, in particular more than two separating elements.

Engagement in the stack refers here to the state in which all separating elements of the plurality engage in the stack or rest against it.

The arrangement of the plurality of separating elements around the stack is such that a stack of articles can be positioned such that those separating elements of the plurality which engage in the stack at the same time engage between the same two articles of the stack.

An engagement in the stack by the plurality of separating elements between an end article of the stack and its nearest neighbor allows the outer article to be moved away from the stack along the stack axis by a suitable process, while the rest of the stack is prevented by one or more separating elements from following this article, either by falling or due to adhering to this article.

The movable mounting of the separating elements allows the separating elements to assume different radial positions in relation to the stack. The separating elements of the plurality can assume a position in which they engage in the stack or lie against it, as well as a position in which they do not do so and thus do not prevent the entire stack from moving along the stack axis.

The individual resilient mounting pushes the respective separating element towards the position at which it engages between two adjacent articles in the stack, provided there is a stack and the stacking position is suitable, as long as the mechanism for moving the separating elements outwards is not active. If a separating element hits the stack at a location where there is not a sufficiently large gap between the articles to engage there, the spring force is selected so that it rests against the stack without damaging the articles.

Furthermore, the device comprises a mechanism for moving the separating elements of the plurality, within their range of motion outwards, into a position of non-engagement in the stack. When the mechanism is activated, the separating elements of the plurality are moved outwards away from the stack, counter to the spring force of their resilient mounting. The mechanism is also capable of holding the separating elements in position without interfering with the stack for the duration of its activation. Deactivation of the mechanism subjects the separating elements to the spring force of their resilient mounting, and, if a stack is present, they engage in the stack or lie against it.

This mechanism makes it possible to position the stack appropriately relative to the separating elements before each de-stacking. Separating elements and stacks can be oriented in such a way that, when the mechanism is deactivated, the spring force pushes the separating elements towards the gap between the article now to be separated from the stack and the next adjacent article in the stack. For example, a design can be selected in which the stack falls onto a carrier when the mechanism is activated, and the gap between the next article to be de-stacked and its neighbor is then exactly at the level of the separating elements.

The advantage of the device presented is that the individual, selectively resilient separating elements only engage in the stack, even without controlled activation, when the respective separating element finds a sufficiently large gap between the articles to be separated. In this way, it can be achieved that, during each de-stacking process, enough separating elements engage in the stack to separate an article of the stack from the stack, even if the gap between the article to be de-stacked and a neighboring article has an irregular size along the periphery of the stack. The remaining separating elements rest on the stack without damaging the articles in the stack or being damaged themselves, and without disrupting the de-stacking process. In addition, the separating elements and their resilient mounting can, if required, be arranged in such a way that the spring force, at least mainly, does not run in the direction of the stack axis. As a result, a force component parallel to the stack axis acting upon the separating elements will not force the separating elements from the stack-engaged position to the non-engaged position.

Preferably, the separating elements are resiliently mounted in such a way that they are pressed radially inwards against the stack. This means that the separating elements are pressed in a straight line towards the stack axis. In particular, these lines, for all separating elements, lie substantially in the same plane perpendicular to the stack axis. However, embodiments are also possible in which the radial movement takes place along a line inclined to the stack axis or in which the separating elements are moved along a curved path with a radial movement component.

This design has the advantage that the separating elements each cover a comparatively small region of space around the stack in their range of motion, while the shape of the separating elements remains the same, and can therefore also individually engage in a narrow gap between the articles.

Alternatively, the radial movement of the separating elements is achieved by a pivoting movement about an axis outside the stack, e.g., pivoting about an axis parallel to the stack axis.

In a preferred embodiment of the invention, the plurality of the separating elements comprises at least three, in particular at least four, separating elements, wherein a maximum angular distance between adjacent separating elements is less than 180°, i.e., along the periphery, there is no contiguous angular region without a separating element that has an extent of 180° or more.

This ensures that, particularly for articles that are themselves symmetrical with respect to the stack axis, there are always enough separating elements in the stack, regardless of their position in the stack.

Preferably, the device has a guide within which the stack of articles to be de-stacked can be located. This prevents unwanted movement of the stack that does not run along the stack axis.

Alternatively, such a guide can be dispensed with. However, depending upon the nature of the articles to be separated, this can lead to the stack becoming prone to failure and falling apart uncontrollably.

The guide may consist of a tube whose inner diameter is selected so that the stack fits into the tube if the stack axis and the symmetry axis of the tube coincide. Alternatively, for example, several rods running parallel to the stack axis can be arranged around the stack in such a way that they guide the stack of articles.

Preferably, the plurality of separating elements are arranged at one end of a guide as described above, wherein the end means a part of the guide which is at the end in the direction of the stack axis.

This has the advantage that the separating elements can hold the stack within the guide, while the article to be de-stacked can be gripped by another component without the guide limiting the space for this component.

Alternatively, the separating elements can also extend through recesses within the guide. However, other components, such as a structure for gripping the article to be de-stacked, would then also have to take the extent of the guide into account in terms of design.

In a preferred embodiment of the invention, the mechanism for moving the separating elements includes a sleeve by the movement of which along the stack axis the separating elements of the plurality are moved radially. Due to its shape, this sleeve presses, depending upon its position along the stack axis, on the resilient mounting of the separating elements of the plurality and can prevent them from engaging in the stack in the opposite direction to their spring direction.

Alternatively, it would also be possible to have a plurality of pneumatically extendable and retractable levers, which, as of a certain extension level, individually press against a connecting element of the separating elements. However, this would be a more complicated structure.

Preferably, the plurality of the separating elements are arranged transversely to a stack axis, circularly around the stack and radially oriented.

Circularly means that the separating elements of the plurality are located on the periphery of a circle whose radius is transverse to the stack axis and whose center lies on the stack axis, as long as all separating elements occupy the same position within their respective range of motion.

The radius of this circle is again chosen so that the separating elements can assume the positions described further above within their range of motion, also described further above.

Alternatively, the separating elements can for instance also be arranged at different heights relative to the stack axis and then engage in the stack at different angles relative to a straight line that is transverse to the stack axis and crosses the stack axis. However, this is more complicated to achieve.

Radially oriented means that all separating elements of the plurality are oriented in the same way with respect to the stack axis, as long as they each are at the same distance from the stack axis. Particularly preferably, the plurality of the separating elements are evenly distributed over the circle periphery which they describe with their arrangement.

Preferably, the invention is implemented in such a way that an article to be removed from the stack can be temporarily fixed by means of a carrier movable along the stack axis. This allows the removal of a stacked article by fixing and then moving the carrier together with the article to be removed, while the separating elements prevent the rest of the stack from following. The carrier can be moved along the stack axis to the article to be de-stacked so that it is able to fix it. With the article fixed and the separating elements engaged, the carrier can then de-stack the article by moving it along the stack axis, away from the stack. Ending the fixation then allows the de-stacked article to be removed from the carrier and reused.

Alternatively, a subset of the separating elements described above can be movably mounted along the stack axis and thus, after engaging in the stack, can separate an article from the stack by a movement along the stack axis. However, this is more complicated to achieve from a construction point of view.

In a preferred embodiment of the invention, the carrier described above comprises a suction device for generating a negative pressure between a wall of an article to be removed and the carrier. The resulting negative pressure fixes the article in the carrier.

Alternatively, a carrier can also fix the article by gripping it or by using an adhesive surface. The advantage of a suction device is the tolerance with respect to the orientation of the article to be removed from the stack. In addition, switching the suction device on and off can activate or release the fixation very precisely, and the negative pressure acts upon a relatively large area of the article, which minimizes point-like forces and thus damage to the article.

Preferably, there is a flexible sealing ring on the carrier for sealing between the carrier and the article to be removed. A flexible, e.g., foam-like, sealing ring allows the creation of a negative pressure between the carrier and an article wall, with an increased tolerance for different orientations of the article compared to inflexible rubber seals. Tests have shown that this can achieve suction of articles tilted up to 30° relative to the stack axis.

In a particularly preferred embodiment of the invention, the carrier comprises two suction devices which are designed as coaxially arranged bellows suckers. The mouth of an inner bellows sucker is arranged further inside the carrier than a very flexible mouth of an outer bellows sucker. The inner bellows sucker has the task of pulling the article to be de-stacked far enough into the outer, more flexible bellows sucker to allow a negative pressure between the outer sucker and the article. As soon as the article sits sufficiently tightly on the outer bellows sucker, the stronger negative pressure of the outer sucker takes effect. This negative pressure then leads to a compression of both bellows suckers, wherein the outer bellows sucker rests on the carrier. By placing the outer bellows sucker on the carrier, it can no longer be compressed, and the article can be oriented by the negative pressure in the carrier, such that, for example, the edge of the article or parts of the article rest against the mouth of the bellows sucker.

Alternatively, the carrier can also contain only a suction system for generating the negative pressure. Here, the steps of creating a good seal between the article and the carrier, orienting and fixing the article on the carrier, and removing the article from the stack using a sucker must be carried out.

The method according to the invention for de-stacking a stack of articles comprises the following steps:
a) providing the stack of articles;
b) positioning the stack of articles such that an end article of the stack rests on a plurality of separating elements;
c) moving the separating elements of the plurality away from the stack by a mechanism;
d) repositioning the stack, in particular by dropping onto a carrier, so that the separating elements, in a position of their range of motion facing the stack, engage between the end stacked article and an article adjacent to it;
e) releasing the separating elements of the plurality from the mechanism for moving the separating elements away from the stack, wherein the separating elements of the plurality are urged by a spring force for engaging in the stack;
f) moving the article lying at the end of the stack away from the stack, in particular by fixing and removing the article using a movable carrier;
g) repeating steps c-f until a desired degree of de-stacking is achieved, or all articles in the stack have been de-stacked.

Preferably, during step d) of the method described above, the stack is repositioned with respect to the separating elements by falling and subsequently stopping the fall by a component.

This means that, after the separating elements have been moved out by activating the mechanism, the stack is moved by gravity and then stopped in its fall at the appropriate height so that the separating elements can engage between the next article to be de-stacked and its neighbors.

As an alternative to falling, movable sliding elements can act upon one or both ends of the stack to move the stack suitably along the stack axis. This is of course more complex to achieve than using gravity, but remains an option if falling is not practical, e.g., due to space constraints.

In a preferred embodiment of the method, the article to be de-stacked of the stack comes into contact with a carrier before step e). Here, the carrier is a component that is able to carry the article to be de-stacked individually and to prepare it for further use.

Alternatively, the de-stacked article can also fall directly onto a conveyor belt in step f) and can be transported from there for further use.

In a preferred embodiment of the method, the article to be separated is temporarily fixed by a carrier movable along the stack axis and, while it is fixed to the carrier, is removed from the stack by the carrier within its range of motion moving away from the stack. In this case, the carrier can move before step f), particularly preferably before step e), in such a way that it comes into contact with the article to be de-stacked and then fixes it. If the article is fixed to the carrier, the carrier is moved away from the stack during step f), thus also removing the article from the stack. Releasing the fixation of the article on the carrier then makes further use of the article possible.

The advantage of this method is that, after de-stacking, the article is already sitting on an individually controllable component and can therefore be reused in an individually controlled manner, unlike if it were on a conveyor belt, for example.

Alternatively, the article can be moved away from the stack by other means. For example, a subset of the plurality of the separating elements can carry out a movement along the stack axis after step e) and thus detach the article to be de-stacked from the stack and let it fall onto a conveyor belt, for example.

Preferably, in the method, the article to be de-stacked is temporarily fixed to the carrier by a negative pressure. After contact has been established between the article and the carrier, a suction device is activated, creating a negative pressure between an article wall and the carrier. As long as the sucker remains activated, the article is fixed to the carrier and can be de-stacked as described above. The advantage of this method is that the negative pressure fixes the article reliably compared to other methods, but the fixation can be released quickly.

Alternatively, another method can be used to temporarily fix an article to the carrier—for example, by means of gripping elements attached to the carrier. However, this depends upon the shape of the articles and can be more difficult to accomplish.

Further advantageous embodiments and combinations of features of the invention can be found in the following detailed description and the entirety of the claims.

### BRIEF DESCRIPTION OF THE DRAWINGS

The drawings used to explain the exemplary embodiment show:

FIG. 1.1 a cross-sectional view of a first embodiment of the device according to the invention in a plane containing the stack axis of the stacked articles;

FIG. 1.2 an isometric plan view of the first embodiment;

FIG. 1.3 a direct plan view of the first embodiment;

FIG. 2.1 a cross-sectional view of a second embodiment of the device according to the invention with a different carrier;

FIG. 2.2 a detail view from FIG. 2.1 around a separating element, on an enlarged scale;

FIG. 3.1 a cross-sectional view of a third embodiment of the device according to the invention in a plane containing the stack axis of the stacked articles;

FIG. 3.2 a detail view from FIG. 3.1 around a separating element, on an enlarged scale;

FIG. 3.3 an isometric plan view of the third embodiment; and

FIG. 3.4 a direct plan view of the third embodiment;

FIG. 4 a cross-sectional illustration of a method for de-stacking capsules by the first embodiment of the device according to the invention.

In principle, identical parts in the figures are provided with identical reference signs.

### WAYS TO IMPLEMENT THE INVENTION

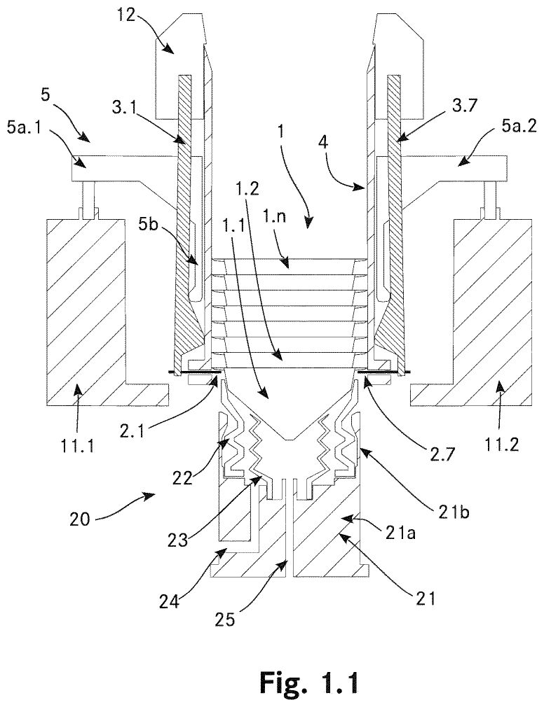

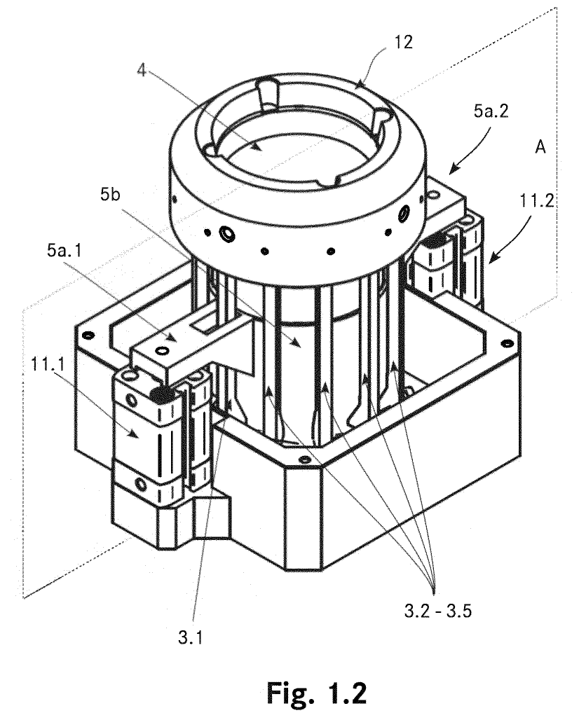

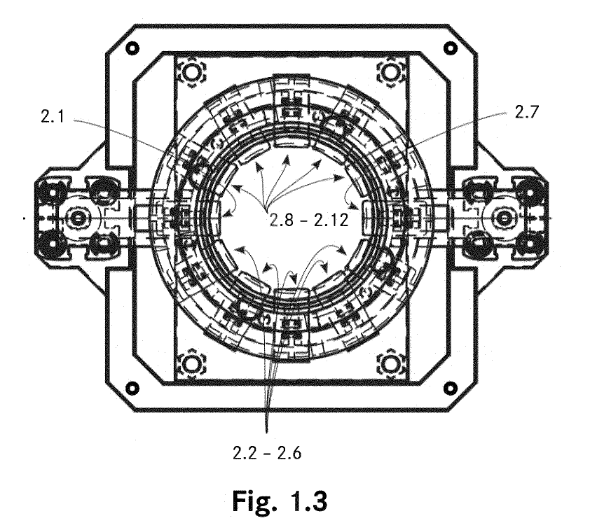

FIG. 1.1, 1.2, and 1.3 show a first embodiment of the device according to the invention-here, for de-stacking a stack of cup-like capsules made of a fiber material-wherein FIG. 1.1 is a schematic sectional drawing, while FIG. 1.2 shows the device in an isometric plan view from the outside. The plane of section chosen for FIG. 1.1 can be seen in FIG. 1.2 as a dashed outline A.

The selected plane of section of FIG. 1.1 contains the stack and symmetry axis of a stack 1 of cup-like capsules 1.1-1.n made of a fiber material, wherein this axis is again upright in the image plane.

The device comprises a guide 4, designed as a tube with a circular cross-section, the symmetry axis of which lies on the same straight line as that of the stack 1 of the cup-like capsules 1.1-1.n. The tube inner diameter is adapted to the outer diameter of the capsules 1.1-1.n to be accommodated, and the tube length to the maximum height of the stacks to be processed, wherein the stack 1 shown is significantly shorter. The wall thickness of the guide 4 is constant and amounts to approximately 5% of the inner diameter.

At the lower end of the guide 4 is the lowest capsule 1.1 of the stack 1 to be de-stacked. Like all capsules 1.1-1.n of the stack 1, the cylindrically symmetric capsule 1.1 has a flat top and a conical cup-like body that tapers downwards and ends in a flat underside. The conical shape of the body of the capsule 1.1 has a smaller opening angle in the upper region, over a portion of about one third of its height, and thus a less pronounced taper towards the bottom than the lower region of its body. The underside of the capsule 1.1 is a significantly smaller surface than the top and is again perpendicular to the symmetry axis of the capsule 1.1.

At its top, an edge protrudes beyond the body of capsule 1.1 and away from its symmetry axis. The symmetry axis of the capsules 1.1-1.n coincides with the symmetry axis of the guide 4. The capsules 1.1-1.n are open at their top and therefore fit into each other when stacked, wherein only a small part of a capsule, e.g., 1.2, including the protruding edge, protrudes from the respective lower neighboring capsule-here, 1.1.

The capsule 1.1 is positioned here so that the underside of its edge is flush with the underside of the guide 4, and the capsule body protrudes downwards from the guide 4.

FIG. 1.3 shows that 12 separating elements 2.1-2.12 are arranged on the periphery of the lower end of the guide 4, evenly distributed over the periphery. The two separating elements 2.1 and 2.7 visible in the cross-section of FIG. 1.1 are located diametrically opposite each other and extend under the guide 4 to below the edge of the lowest capsule 1.1. Its cross-section has the shape of a rectangle with a length greater than the wall thickness of the guide 4. FIG. 1.3 also shows that the separating elements have a rectangular shape in plan view, with a width that is approximately half their length.

The separating elements 2.1-2.12 are each connected to a leaf spring 3.1-3.12, which presses the respective separating element radially inwards, in the direction of the stack 1. In FIG. 1.2, the leaf springs 3.1 and 3.2-3.6 are visible, while in FIG. 1.1, only the two leaf springs 3.1 and 3.7 are visible.

The leaf springs 3.1-3.12 are located outside the guide 4 and run parallel to it from their suspension at the upper end of the guide 4 to a separating element 2.1-2.12 at the lower end. The upper ends of the leaf springs are suspended in a flange-like upper part 12 of the guide 4.

The cross-section of each leaf spring 3.1-3.12 has, in an upper region which extends over most of the length of the leaf spring 3.1-3.12, the shape of an elongate rectangle with a thickness comparable to the wall thickness of the guide 4 and a height comparable to the length of the guide 4.

The lower region of each leaf spring 3.1-3.12, which is located directly above the respective separating element 2.1-2.12, has a thickening which is located on the side facing the stack 1 and increases towards the bottom. The leaf spring 3.1-3.12 grows to a maximum of about twice the thickness, compared to the upper part of the spring. At its maximum thickness, the thickness of the leaf spring 3.1-3.12 remains constant over a short distance and then tapers again towards the bottom. Here it takes on a thickness that is narrower than its upper part. The narrow lower region of each leaf spring 3.1 3.12 protrudes into a hole, parallel to the drawing plane, in the respective separating element 2.1-2.12, whereby the spring force acts transversely to the stack axis upon the respective separating element 2.1-2.12. The depth of the leaf springs 3.1-3.12 can be seen only in FIG. 1.2 and corresponds approximately to the thickness in the upper region of each leaf spring 3.1-3.12.

The leaf springs 3.1-3.12 are mounted in such a way that the region of maximum thickness would have to penetrate into the guide 4 for the spring to be completely relaxed. As a result, they are permanently in the tensioned state and rest against the guide 4, which in turn also defines the stack-side end position of the range of motion of the separating elements 2.1-2.12.

In the isometric plan view according to FIG. 1.2, the guide 4 appears as a tube with a round opening upwards, which stands upright in the image plane. The suspension 12 of the leaf springs 3.1-3.12 sits on the upper end of the guide 4. The leaf springs 3.1-3.5 are arranged on the outside of the guide 4. They run parallel to the guide 4 and are evenly distributed around its periphery. The width of the leaf springs 3.1-3.12 is significantly less than one-twelfth of the outer guide periphery, i.e., there are larger gaps between the leaf springs 3.1-3.12.

Outside the guide 4, there is also a sleeve 5 for moving the separating elements radially outwards.

The sleeve 5 has a tubular body 5b with a slightly larger inner diameter than the outer diameter of the guide 4. The wall thickness of the tubular part 5b is selected so that it fits between the guide 4 and the upper part of the leaf springs 3.1-3.12.

The tubular part 5b of the sleeve 5 shares the same symmetry axis with the guide 4, is arranged axially displaceably on the guide 4, and is surrounded by the leaf springs 3.1-3.12. At the lower edge of the sleeve 5, there is a bead-like thickening which is directed outwards, in the direction of the leaf springs 3.1 -3.12, wherein the wall thickness of the sleeve 5 is approximately doubled here.

In addition, the sleeve 5 has two arms 5a.1 and 5a.2 extending radially outwards from the sleeve body 5b, which are connected to lifting elements 11.1 and 11.2, wherein the arms 5a.1 and 5a.2 of the sleeve 5 each encompass the leaf springs 3.1 and 3.7 (see FIG. 1.2), so that the leaf springs 3.1-3.12 are gripped by the sleeve 5 only at the lower end.

In FIG. 1.1, the sleeve 5 is positioned so that it does not touch the leaf springs 3.1-3.12.

In an upper region of the sleeve 5, two carrier parts (5a.1 and 5a.2 in FIG. 1.2) protrude horizontally radially outwards on both sides of the guide 4 and at approximately half of its height, and are each connected on their underside to a lifting element 11.1 and 11.2.

If the sleeve 5 is moved downwards with the aid of the lifting elements 11.1 and 11.2, the lower thickening of the sleeve 5 presses against the thickening of the leaf springs 3.1-3.12 and thus forces their lower region away from the stack axis. This also moves the separating elements 2.1-2.12 away from the stack axis into a position without engagement in the stack.

Below the capsule 1.1, there is a carrier 20 for fixing and pulling the capsules away from the stack, again consisting of the components 21-25. The carrier 20 has an overall cylindrical shape, wherein its cylinder axis lies on the same straight line as the symmetry axis of the guide 4. Its outer diameter corresponds approximately to the inner diameter of the guide 4, and its length approximately to half the length of the guide.

The largest part of the carrier 20 is the carrier base 21. This carrier base 21 is solid in its lower half 21a, while the upper half 21b is hollowed out by a recess coming from above to such an extent that the carrier base 21 is limited to a thin outer wall.

In the lower part 21a of the carrier base 21, there are two holes 24 and 25. The first hole 25 lies on the symmetry axis of the carrier base 21 and pierces it completely, opening into the upper recess. The second hole 24 is located outside the symmetry axis and, also coming from above, runs to approximately half of the solid part 21a of the carrier base 21 and from there horizontally outwards, again completely penetrating the carrier base 21.

The other two main parts of the carrier 20 are formed by two, coaxially extending bellows 22, 23, which are located within the upper recess of the upper part of the carrier base 21a. The outer diameter in the lower region of the first bellows 22 is adapted to the inner diameter of the recess in the carrier base 21. Its symmetry axis lies on the same straight line as the symmetry axis of the carrier base 21, the guide 4, and the stack 1. The length of the bellows 22 allows about one-third of the bellows 22 to protrude from the top of the walled region 21a of the carrier base 21, whereby the upper end of the bellows 22 forms the highest point of the carrier 20. The outer diameter of the mouth of the bellows 22, which is located outside the carrier base 21, is approximately equal to that of the carrier base 21.

The bellows 22 is open at the top, and the mouth at this end can be completely closed from the bottom of the capsule. If the carrier 20 and the capsule 1.1 touch each other, a negative pressure can be generated via the hole 24 within the bellows 22, and the capsule 1.1 can thus be fixed to the carrier 20.

The second bellows 23 runs coaxially to the bellows 22 and lies within it with a smaller diameter. It is also attached to the bottom of the carrier base 21 and has an upper open mouth pointing towards the bottom of capsule 1.1. However, its length is shorter than that of the bellows 22, and its upper mouth is approximately at the level of the upper edge of the carrier base 21.

The volume within the bellows 23 can be evacuated via the hole 25 if the capsule wall (e.g., of capsule 1.1) closes it off at the top.

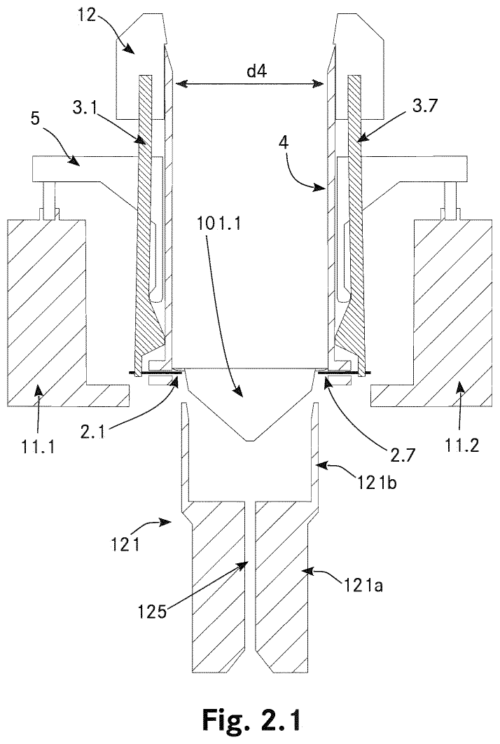

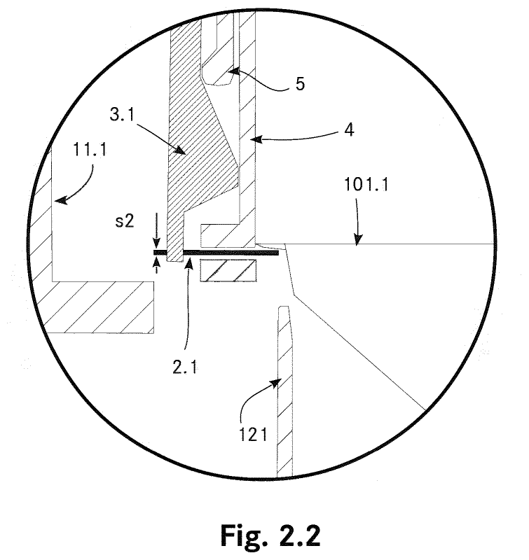

FIG. 2.1 shows a second embodiment of the device according to the invention, again as a cross-section, analogous to FIG. 1.1. The structure of the device differs from the device in FIG. 1.1 and 1.2 by a different shape of the carrier, which here consists exclusively of the carrier base 121 with the hole 125. The marking of components that do not differ from the form shown in FIG. 1.1 has been retained.

The carrier base 121 has a similar shape and the same placement as the carrier base 21 from FIG. 1.1 and is cylindrically symmetrical. In an upper region 121b, the carrier base 121 is tubular and open towards the top, wherein this region, along its symmetry axis, constitutes slightly less than half of the carrier base 121. The inner diameter of the tubular region 121b is selected such that the carrier base 121 can be completely covered by the lower wall together with the edge of the capsule 101.1, but, at the same time, the capsule can enter up to its edge the upper region 121b of the carrier base 121. The inner diameter of the upper region 121b of the carrier base 121 tapers slightly from above, thereby improving the fit of the capsule 101.1 on the carrier base 121.

This also means that the inner diameter of the tubular portion 121b is smaller than the inner diameter d4 of the guide 4. The outer diameter of the region 121b corresponds approximately to the inner diameter d4 of the guide 4. The lower region 121a, which constitutes the remainder of the carrier base 121, is cylindrical and solid, wherein it has an outer diameter approximately equal to the inner diameter of the portion 121b. The two regions 121a and 121b are directly connected, and the underside of the tubular region 121b is completely closed by the top side of the cylindrical region 121a. Lying on the symmetry axis of the carrier base 121, there is a hole 125 which completely pierces the lower region 121a of the carrier base 121. If a capsule is seated on the carrier base 121, the volume within the tubular region 121b and below the capsule can be evacuated via this hole, thus fixing the capsule on the carrier base 121. The main difference from the carrier in FIG. 1.1 is the absence of the concentric bellows (22 and 23 in FIG. 1.1) and the two individually evacuatable regions within these bellows.

FIG. 2.1 shows a capsule 101.1 of the same shape as the capsule 1.1 in FIG. 1.1. In this capsule 101.1, the body is more bell-shaped towards the bottom. The inner diameter d4 of the guide 4 has a value of 61 mm in this design.

FIG. 2.2 shows a circular detail of FIG. 2.1 on a larger scale, in which the region where the separating element 2.1 engages under the edge of the capsule 101.1 is in the center. The thickness s2 of the separating elements 2.1-2.12 is 0.5 mm.

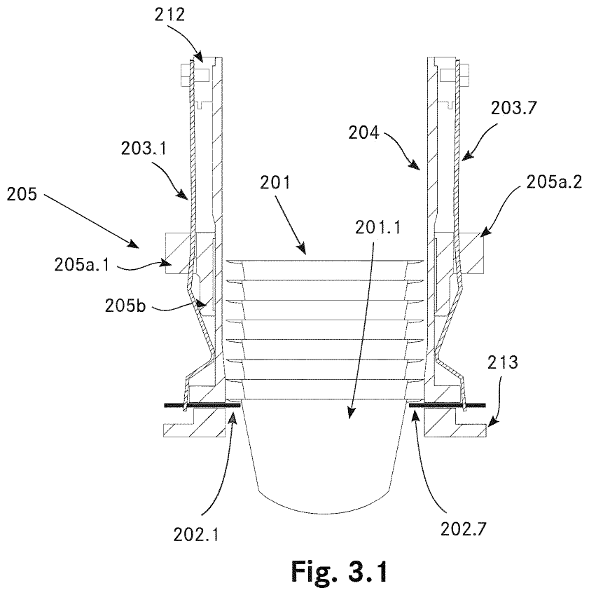

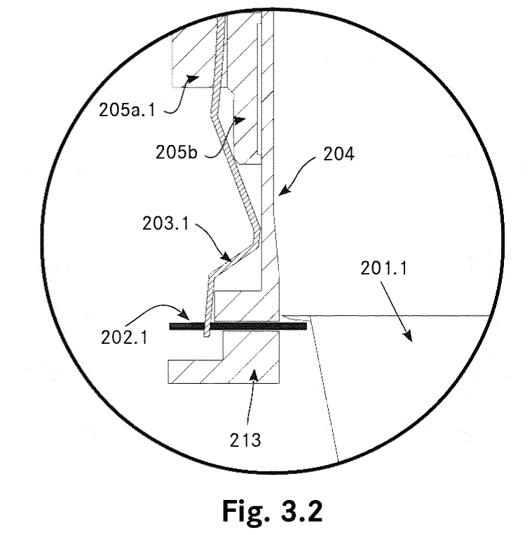

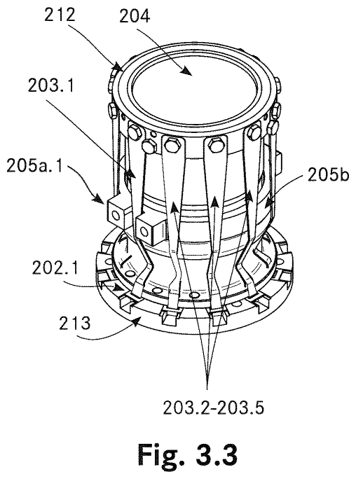

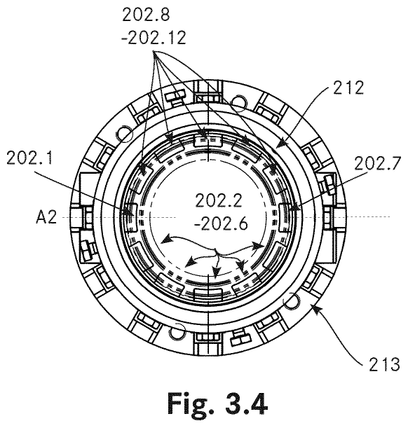

FIG. 3.1 shows a third embodiment of the device according to the invention, again in cross-section. This design is also suitable for de-stacking a stack 201 of cup-like capsules. For the sake of simplicity, no device for moving the capsules away from the stack is shown. For this purpose, for example, the carrier 21 shown in FIG. 1.1 or the carrier 121 from FIG. 2.1 can be used. FIG. 3.1 shows the device as a schematic sectional drawing in which the sectional plane contains the stack axis of the stack 201. FIG. 3.2 shows a detail of FIG. 3.1 on a larger scale, FIG. 3.3 shows the same device as an isometric plan view, and FIG. 3.4 shows the device as a direct plan view, wherein the plane of section A2 of the cross-sectional drawing according to FIG. 3.1 is drawn here.

The orientation of FIG. 3.1 is analogous to FIG. 1.1, and the stack axis is upright in the image plane, wherein the belly of the capsules points downwards. The stack 201 is located in a guide 204 which is tubular and the symmetry axis of which coincides with the stack axis. FIG. 3.1 also shows a different capsule shape than that shown in FIG. 1.1-FIG. 2.2. The capsule 201.1 of the stack 201 also has a body that tapers conically towards the bottom, but with a uniform opening angle over the entire capsule body. In contrast to capsule 1.1 from FIG. 1.1, the underside of capsule 201.1 is curved downwards and not flat.

The guide 204 has along its length two different regions with a constant inner diameter, with a lower region whose inner diameter corresponds approximately to the outer diameter of the stack 201 and an upper region with a slightly larger inner diameter. The lower region makes up about one-tenth of the total length of the guide 204. From the first to the second region, there is a linear transition of the inner diameter, which also represents about one-tenth of the total length of the guide 204.

The guide 204 has a length of approximately twice its smallest inner diameter. The outer diameter of the guide 204 also varies, wherein the upper half of the guide 204 has a slightly larger outer diameter than the lower half, wherein the larger outer diameter is approximately 15% larger and the smaller outer diameter approximately 7% larger than the inner diameter of the guide 204.

The lower end of the guide terminates with a flange to which the retaining ring 213 is attached, which in turn on its upper side, which is in contact with the underside of the flange of the guide, contains recesses in which the separating elements 202.1-202.12 are located and can move radially with respect to the stack axis.

Below the guide 204, the separating elements 202.1-202.12, whose diametrically opposite elements 202.1 and 202.7 are located in the plane of the drawing, extend from outside the guide 204 in the direction of the stack axis, so that the stack cannot leave the guide 204 at this end. They have a length of approximately twice the wall thickness of the guide 204.

Comparably to the embodiment presented in FIG. 1.1, leaf springs 203.1-203.12 run along the outside of the guide 204 from the upper end of the guide 204 to its lower end. In this embodiment, however, the leaf springs 203.1-203.12 have a different shape. They have along their length the same thickness, which is very small relative to their length. For this purpose, they have a curved profile: the upper end of each leaf spring is screwed to a flange-like structure 212. From this attachment, they initially run downwards parallel to the guide 204. Within their lower third, the leaf springs 203.1 203.12 bend towards the stack 201 and thus run diagonally inwards, towards the guide 204. Shortly above the end of the guide 204, the leaf springs 203.1-203.12 bend back and run outwards again away from the guide 204. Flush with their upper part, they make another bend just before their lower end and then run parallel to the upper part further downwards, slightly beyond the end of the guide 204. Due to their attachment, the leaf springs 203.1-203.12 cannot assume their completely relaxed shape in the device, but with their radially furthest inward-extending portion are pretensioned on the outside of the guide 204. The lower region of the leaf springs 203.1-203.12 extends into a recess within the separating elements 202.1-202.12, whereby the spring force is transferred to the separating elements 202.1-202.12.

The mechanism for moving the separating elements away from the stack is realized by a sleeve 205 with a tubular body 205b. The inner radius of its body 205b is slightly larger than the outer radius of the guide 204, and the body 205b is arranged coaxially with the guide 204 and axially displaceably, and is located between the guide 204 and the leaf springs 203.1-203.12. The length of the sleeve 205 corresponds to approximately one-quarter of the length of the guide 204 and it is located at the level of the lower region of the guide 204, where its outer diameter is reduced. The outer diameter of its body 205b allows the sleeve 205 to assume a position where it does not touch the leaf springs. The sleeve body 205b itself has two approximately equally large regions with various outer diameters, wherein the upper region has a larger outer diameter than the lower region. In addition, the lower outer edge of the body 205b of the sleeve 205 is rounded. Connecting elements 205a.1 and 205a.2 are located on the upper part of the sleeve body 205b and project radially from the guide 204 and beyond the leaf springs 203.1-203.12. These have an almost square cross-section, with the edge length of their cross-section being approximately half the length of the sleeve body 205b, whereby they are located only on the region with the larger outer diameter of the sleeve body 205b.

FIG. 3.2 shows a detail of FIG. 3.1 on a larger scale, in which, as in FIG. 2.2, the region around a separating element can be seen more clearly.

FIG. 3.3 shows the same embodiment of the invention as FIG. 3.1 and 3.2, this time in an isometric plan view. The structure of the assembly is determined by the guide 204, to the upper edge of which the twelve leaf springs 203.1-203.12 are attached with a screw in each case, wherein, in the view of FIG. 3.3, the leaf springs 203.1-203.5 are marked. The leaf springs 203.1-203.12 have their greatest width, of approximately one twenty-fourth of the guide periphery, at the point of their attachment and taper linearly to approximately one-quarter of their original width up to the first bend in their lower region. From here, their width remains constant until the second bend and then increases again until the third bend. The width of their lower region, which also enters the recesses in the separating elements 202.1 202.12, is less than the width at their suspension. The connecting elements 205a.1 and 205a.2 of the sleeve are located in the regions of the leaf springs 203.1 and 203.7. Each connecting element 205a.1 and 205a.2 itself consists of two connecting pieces, on each side of the respective leaf spring 203.1 and 203.7, which are attached to the tubular sleeve body and protrude outwards between the leaf springs 203.1 and 203.7 transversely to the stack axis. Each connecting piece is substantially cube-shaped, wherein the two connecting pieces have flush outer sides on one side of the guide 205 and are connected to the sleeve body 205b over their full width.

FIG. 3.3 also shows the shape of the twelve recesses in the retaining ring 213. They are selected in an upper region such that they accommodate the separating elements 202.1-202.12 and keep the upper side of the separating elements flush with the underside of the guide 204. Within the recesses that hold the separating elements 202.1-202.12, there are additional grooves that are slightly narrower, but deeper than the recesses for the separating elements. These grooves accommodate the ends of the leaf springs 203.1-203.12, which protrude beyond the separating elements 202.1-202.12 at the bottom.

FIG. 3.4 shows a direct plan view of the embodiment according to FIG. 3.1-3.3. Here, the symmetry axis of the guide 204 forms the midpoint of the drawing, and the symmetry axis itself passes through the drawing plane. The plane of section A2 of FIG. 3.1 and 3.2 lies horizontally in the plane of the drawing. The shape of the separating elements 202.1-202.12 corresponds to a rectangle with slightly rounded edges, wherein their width corresponds to slightly more than one-twelfth of the guide periphery, and their length is approximately twice the wall thickness of the guide 204. They are evenly distributed over the periphery of the guide 204 (FIG. 3.1-3.3).

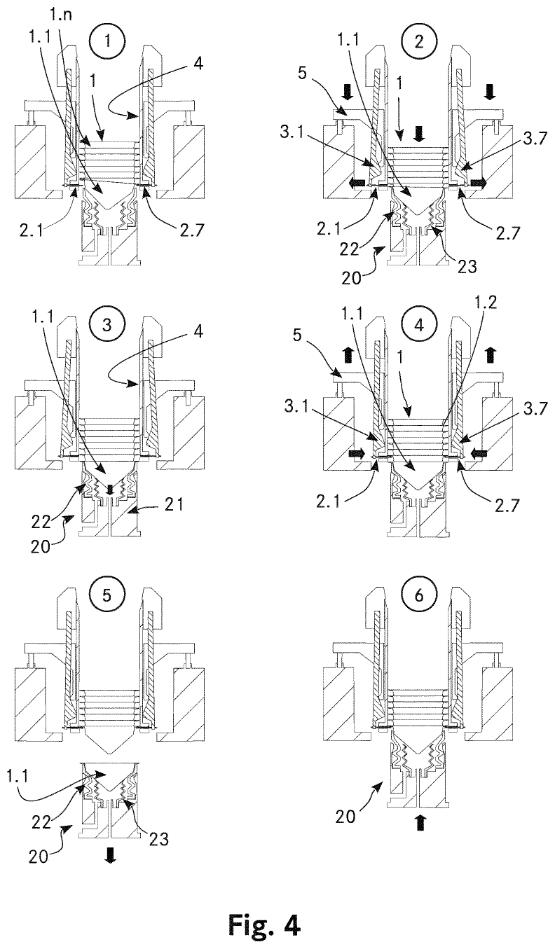

FIG. 4 shows, based upon the cross-sectional drawing of the first embodiment of the device according to the invention from FIG. 1.1, an example of a method for de-stacking a stack of cup-like capsules. In the description, reference is made to the reference signs of FIG. 1.1-1.3, since they show the same device. Of the separating elements 2.1-2.12, only the separating elements 2.1 and 2.7 are shown, as in FIG. 1.1. Similarly, only leaf springs 3.1 and 3.7 are shown. Whenever separating elements or leaf springs are mentioned in the following description, all 12 are meant, even if only the reference signs of the components shown are mentioned.

FIG. 4 contains the method steps 1-6 and shows, based upon these, the de-stacking of the capsule 1.1 of the stack 1.
1. At the beginning of the de-stacking step, the stack 1 of cup-like capsules 1.1-1.n rests on the separating elements 2.1, 2.7. The lowest capsule 1.1 is drawn obliquely with respect to the symmetry axis of the guide 4 in order to illustrate the orientation according to the invention of the capsules 1.1-1.n during de-stacking.
2. By moving the sleeve 5 downwards, the leaf springs 3.1, 3.7 are pushed away from the guide 4, and the separating elements 2.1, 2.7 are pulled out of the stack 1. This causes the stack 1 to fall into the carrier 20. The negative pressure of the inner bellows sucker 23 acts upon the carrier 20, whereby the capsule 1.1 is completely pulled onto the outer bellows sucker 22.
3. The capsule 1.1 lies completely on the mouth of the outer bellows sucker 22. This creates a negative pressure, which leads to the compression of the bellows sucker 22. The outer bellows sucker 22 contracts until its mouth rests on the carrier base 21. The capsule 1.1 is pulled into the carrier 20 up to its edge by the bellows sucker 22 and, by placing the bellows mouth on the carrier base 21, is oriented in the carrier 20 so that its symmetry axis coincides with the symmetry axis of the guide 4. The negative pressure between capsule 1.1 and carrier 20 also fixes the capsule 1.1 to the carrier 20.
4. The sleeve 5 is now moved upwards again, whereby the leaf springs 3.1, 3.7 press the separating elements 2.1, 2.7 in the direction of the stack 1. The separating elements 2.1, 2.7 engage between the edges of the two lower capsules 1.1, 1.2 of the stack 1.
5. The carrier 20 can now move away from the stack with the capsule 1.1 fixed and can supply the capsule 1.1 for further use. After the bellows suckers 22 and 23 have been ventilated, the capsule 1.1 can be removed from the carrier 20 without any effort.
6. After the de-stacked capsule 1.1 has been removed from the carrier 20, the carrier 20 can be moved to the initial position, thus enabling the next de-stacking step.

The invention is not limited to the presented exemplary embodiments. In particular, components such as the separating elements can have a different shape depending upon the specific geometry of the articles being stacked and de-stacked.

It is conceivable, for example, that the separating elements be made significantly narrower, or that their front edge have a rounded shape that is adapted to the shape of the articles to be de-stacked. The number and arrangement of the separating elements around the stack may also differ from the examples presented.

The guide can also have a different shape or even be omitted. For articles that are rectangular when viewed from above, a guide with a rectangular basic shape can be used instead of a tube.

Furthermore, different shapes of the carrier can be used, or even other solutions for moving the capsules away from the stack can be found that do not require a carrier.

The resilient mountings of the separating elements can also be designed differently while maintaining the same functionality, e.g., spiral springs can press on the side of each separating element that is facing away from the stack.

The capsules shown are merely examples of stacked articles that can be de-stacked by the invention. For example, the capsules can also have other body shapes, such as completely convex or bell-shaped. Articles other than capsules, e.g., prismatic packaging elements with a rectangular base, can also be de-stacked by a device according to the invention or the method according to the invention.

In summary, it can be stated that a device having a plurality of individual, resiliently mounted separating elements in conjunction with a mechanism that can move the separating elements into a position without engagement in the stack is capable of allowing effective de-stacking of stacked articles, in particular cup-like capsules, even when the articles are inclined relative to the stack axis, without damaging the articles, wherein the device is simple and cost-effective.

1: A device for de-stacking a stack of articles, the device comprising:
separating elements for engaging between adjacent articles of the stack of articles,
wherein a plurality of the separating elements are arranged in engagement in the stack all around the stack, and the separating elements of the plurality are mounted to be radially movable,
wherein the separating elements of the plurality are each mounted resiliently, and
the device further comprises a mechanism for moving the separating elements of the plurality outwards into a position of non-engagement in the stack.

2: The device according to claim 1, wherein the separating elements of the plurality are mounted resiliently such that they are pressed radially inwards against the stack.

3: The device according to claim 1, wherein the plurality comprises at least three separating elements, wherein a maximum angular distance between adjacent separating elements is less than 180°.

4: The device according to claim 1, further comprising a guide within which the stack of articles to be de-stacked can be located.

5: The device according to claim 4, wherein the plurality of separating elements are arranged at one end of the guide.

6: The device according to claim 1, wherein the mechanism for moving the separating elements includes a sleeve, and the separating elements of the plurality are moved radially by movement of the mechanism along an axis of the stack.

7: The device according to claim 1, wherein the plurality of separating elements are arranged transversely to a stack axis, circularly around the stack and radially oriented.

8: The device according to claim 1, wherein the device further comprises a carrier movable along an axis of the stack, and an article to be removed from the stack can be temporarily fixed by the carrier movable along the axis of the stack.

9: The device according to claim 8, wherein the carrier comprises a suction device for generating a negative pressure between a wall of the article to be removed and the carrier.

10: The device according to claim 9, wherein a flexible sealing ring is arranged on the carrier for sealing between the carrier and the article to be removed.

11: The device according to claim 9, wherein the carrier comprises two suction devices, which are designed in as coaxially arranged bellows suckers.

12: A method for de-stacking a stack of articles, the method comprising:
a) providing the stack of articles;
b) positioning the stack of articles such that an end article of the stack rests on a plurality of separating elements;
c) moving the separating elements of the plurality away from the stack by a mechanism;
d) repositioning the plurality of the separating elements relative to the stack, so that the separating elements, in a position of their range of motion facing the stack, can engage between an end stacked article and an article adjacent to the end stacked article;
e) releasing the separating elements of the plurality from the mechanism for moving the separating elements away from the stack, wherein the separating elements of the plurality are urged by a spring force for engaging in the stack;
f) moving the article lying at the end of the stack away from the stack;
g) repeating steps c-f until a desired degree of de-stacking is achieved, or all articles in the stack have been de-stacked.

13: The method according to claim 12, wherein, during step d), the stack is repositioned with respect to the separating elements by falling and subsequently stopping the fall by a component.

14: The method according to claim 12, wherein the article to be de-stacked of the stack contacts with a carrier before step e).

15: The method according to claim 12, wherein the article to be separated is temporarily fixed by a carrier movable along an axis of the stack, and the article, while fixed to the carrier, is removed from the stack by the carrier within a range of motion moving away from the stack.

16: The method according to claim 12, wherein the article to be separated from the stack is temporarily fixed to the carrier by a negative pressure.

17: The device according to claim 1, wherein the plurality comprises at least four separating elements, wherein a maximum angular distance between adjacent separating elements is less than 180°.

18: The method according to claim 12, wherein the articles are cup-like capsules with a peripheral edge.

19: The method according to claim 12, wherein the repositioning of the plurality of the separating elements relative to the stack comprises dropping the stack onto a carrier.

20: The method according to claim 12, wherein the moving of the article lying at the end of the stack away from the stack comprises fixing and removing the article using a movable carrier.
